(19) United States
(12) Patent Application Publication
(10) Pub. No.: US 2005/0119903 A1
(43) Pub. Date: Jun. 2, 2005

(54) Guided tour system

(76) Inventor: Fu Ching Lee, Los Angeles, CA (US)

Correspondence Address: Fu Ching Lee, P.O. Box 6611, Beverly Hills, CA, 90212, US

(21) Appl. No.: 10/724,466

(22) Filed: Dec. 1, 2003

(51) Int. Cl. G06F 17/60

(52) U.S. Cl. 705/1

(57) ABSTRACT

A guided tour system. Tour data including a plurality of item of interest are stored in a memory array. A user interface allows a user to select a particular tour of interest. The system determines a current location by means of a GPS receiver and along with the selected tour data, a direction and distance to the item of interest is calculated. The direction and distance information is display to the user to aid in directing the user to the item of interest. Once the user arrives at the item of interest, information regarding the item of interest is displayed. A next item of interest is similarly processed until the tour is completed.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a guided tour system, specifically to a portable system that will provide both audio and textual directional information on the selected tour route. Additionally the system will provide audio and textual descriptions of items of interests along said selected tour route.

### BACKGROUND OF THE INVENTION

Tourism is one of the biggest industries in the world. Some countries derive over 50% of their GDPs in tourism dollars alone. As a result, whole industries are created to support this market. One particular market is the Guide Book industry. This segment provides informational books on destinations worldwide providing historical, cultural, topical and countless other data and information. They point out places to stay, eat, visit, and include maps and other current information to arm the tourist prior to the trip. To derive additional information of interest, the tourist relies on guided tours at the destination. These tours can be vehicular or pedestrian and includes a tour guide highlighting the items of interest. These guided tours are a great way to learn more about a destination however there are problems associated with them namely:

Scheduling:

Tours are operated by organizations or companies that provide them at fixed schedules. Finding a tour of your interest to match your schedule can be difficult particularly if you only had a limited time at the destination. Also some tours are canceled if not enough people sign up for it, so you may waste a whole day waiting for a tour only to find out its canceled at the last moment.

Interest:

Tours are offered and targeted to the general public and provide items of interest that are broad and of interest to said target group. Finding a tour on one particular subject can be difficult.

Detail:

The level of detail on a particular item of interest is limited as the operators wants to provide value for money so they pack in as many sights as possible but only spends a brief time on each. For more detail, you are forced to do your own research after the tour.

Flexibility:

Tours operate like clock work, passing certain points in a certain order and spending a certain amount of time at each point. No allowances are made if you wanted to stop at a particular point for a longer time or if you wanted to interrupt the tour at a particular point and resume later.

### BACKGROUND OF THE INVENTION—OBJECTS AND ADVANTAGES

Accordingly, an object of the present invention is to solve the aforementioned problems and to provide a guided tour system in a portable form.

Still further objects and advantages will become apparent from consideration of the ensuing description and drawings.

### SUMMARY

In accordance with the above-mentioned objects and advantages, the present invention consists of an apparatus and method for providing navigational assistance to enable a user to navigate a selected tour route and provide information regarding items of interest along said selected tour route.

### DRAWINGS—FIGURES

FIG. 1 shows different views of a guided tour system;

FIG. 2 shows a block diagram representation of the circuitry of a guided tour system;

FIG. 3 shows a representation of a user's direction relative to magnetic North and a item of interest;.

FIG. 4 shows a representation of a database structure for a memory containing data for plurality of Tour Routes;

FIG. 5 shows a representation of a database structure for a memory containing data for an Item of Interest; and

FIG. 6 shows a simplify flow chart of the method of the guided tour system.

### DETAILED DESCRIPTION

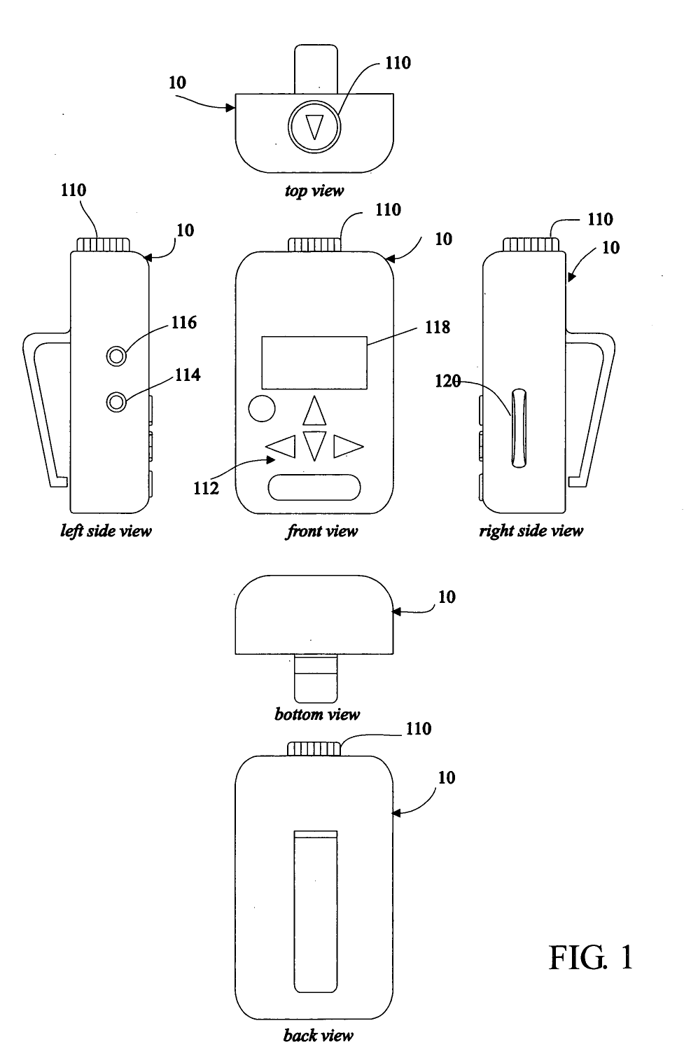

FIG. 1 shows different views of a preferred embodiment of the present invention. A front view shows a guided tour system 10 with a display 118, a keypad 112 and a direction reference selector 110. A left side view shows a line-in socket 114 and a line-out socket 116. A right side view shows a memory module slot 120.

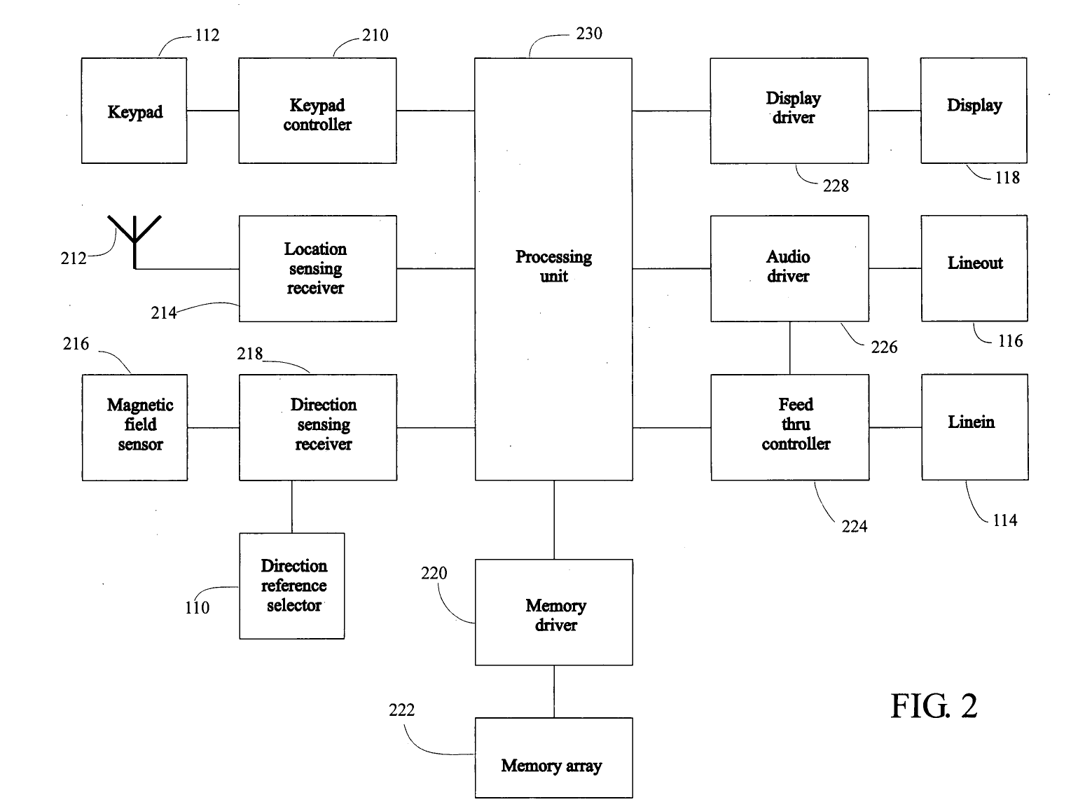

FIG. 2 shows a representation of the circuitry of the guided tour system 10. The guided tour system 10 circuitry includes a processing unit 230 that performs the computational functions for the system. The processing unit can be a micro-controller or the likes. The keypad 112 is decoded by a keypad controller 210 for presentation to the processing unit 230. An antenna 212 couples GPS signals to a location-sensing receiver 214 where it is decoded and presented to the processing unit 230 as a longitudinal and latitudinal representation. A magnetic field sensor 216 senses the earth's magnetic field and allows a direction-sensing receiver 218 to derive a compass heading representation that is presented to the processing unit 230. A memory driver 220 is used to interface with a memory array 222 and provides data to the processing unit 230. The memory array 222 can be of a memory card type commonly found in digital cameras, PDAs and the like. A display 118 is used to provide visual feedback to the user. The display 118 can be an alphanumeric LCD display or the like. The display 118 is driven by a display driver 228 directed by the processing unit 230. An audio driver 226 provides audio drive to the line-out socket 116 where a user can attach headphones for listening. A line-in socket 114 is provided to allow the user to connect an external audio device such as a CD player or the likes. A feed thru controller 224 is used to connect the external audio device to the line-out socket so a user can listen to the external audio device.

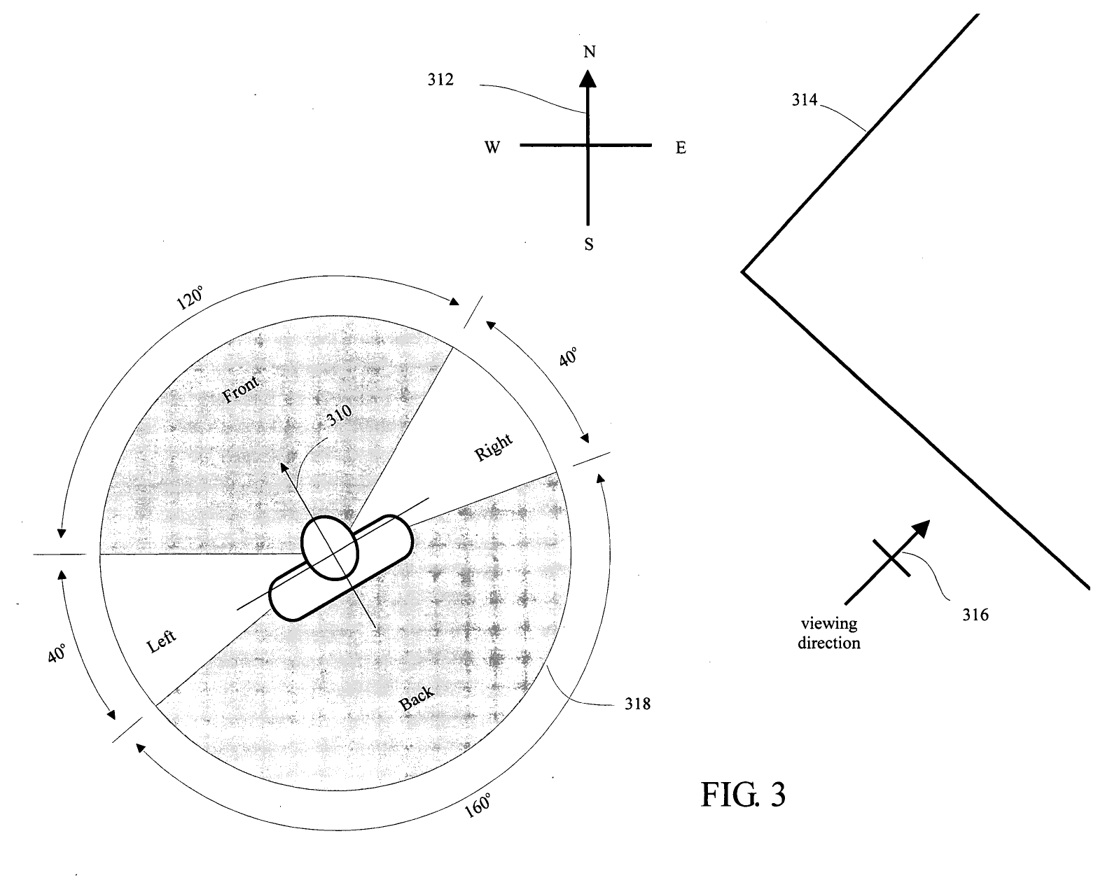

FIG. 3 shows a representation of a user's direction 310 relative to magnetic North 312 and an item of interest 316. Here a user's Front direction is defined as a 120-degree wide segment ahead of the user. Left, right and back are as shown in FIG. 3. A proximate-zone 318 is created as a circle centered on the guided tour system and of 25 feet radius.

Operation of Invention.

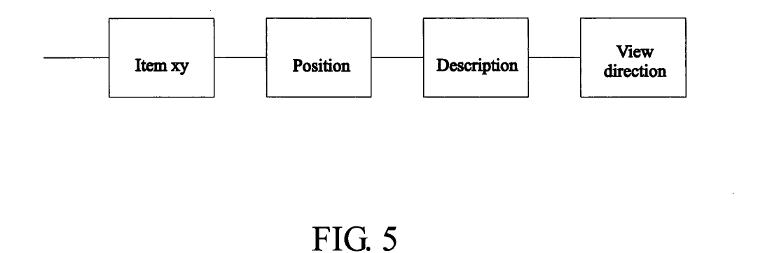

A database of items of interest in a particular region is created and stored in the memory array 222. The structure of the database for each item of interest is shown in FIG. 5 and consists of at least the following information:
Position—the longitude and latitude of the item of interest;
Description—a description of the item of interest, in both audio and textual format;
View direction—the viewing direction of the item of interest reference to magnetic north.

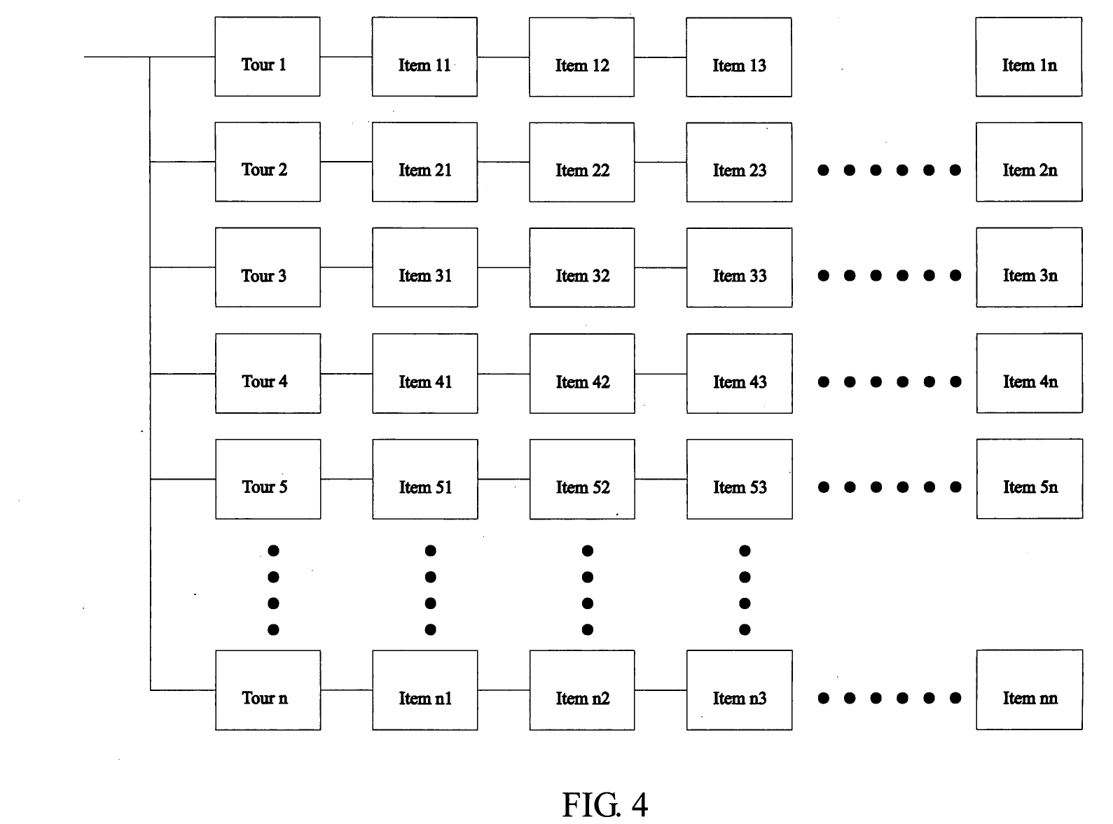

A database of Tours are also stored in the memory array 222. The structure of this database is shown in FIG. 4 and consists of groups of items of interest. For each Tour there is a number of items of interest associated with it, with each item of interest arranged in order as determined by the subject of the tour.

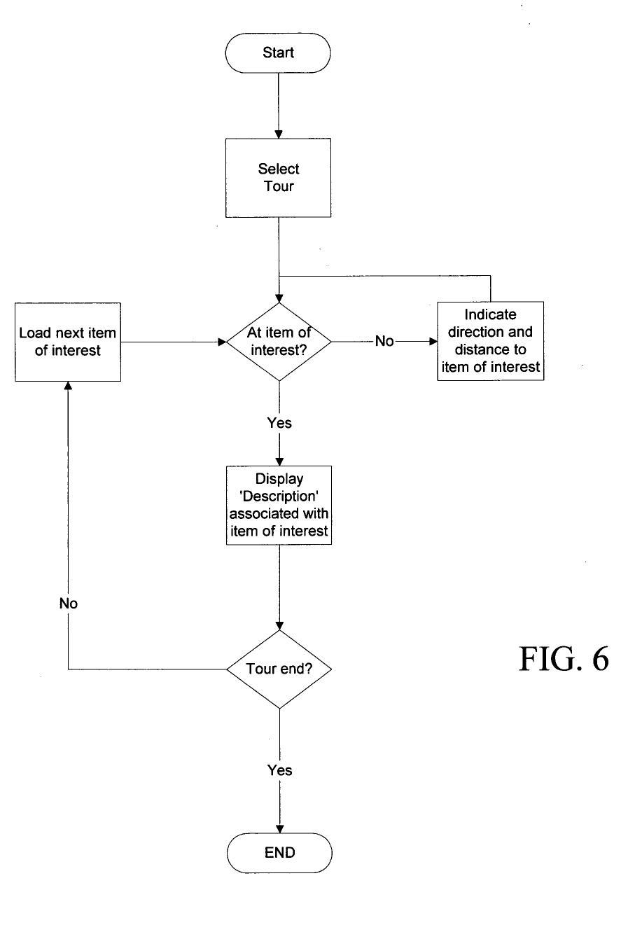

A user, using the keypad, selects one of the Tours stored in the memory array 222. The display 118 is used to provide visual indication to the user regarding the content of the selected Tour. The user adjusts the direction reference selector 110 to point in the same direction as the user's front. This is required because different users may mount the guided tour system 10 in different ways. By setting the direction reference selector 110, the system will know the user's front direction. FIG. 6 shows as a flow chart the program flow of the processing unit 230. Once a tour is selected, the processing unit 230 prompts the user to enter if they want to start at the beginning of the tour or at an item of interest close to the user's current location. Using the keypad 112 the user selects their preference. If the user selects to start from the start of tour then the processing unit will retrieve the data for the first item of interest of the selected tour. If the user selects to start from an item of interest close to current location then the processing unit will determine the guided tour system's 10 current location by reading the longitude and latitude readings from the location sensing receiver 214. Based on these coordinates, the processing unit 230 searches the list of items of interest to find the one closest to the guided tour system's 10 current location. The data for this item of interest will be retrieved by the processing unit 230. The processing unit 230 compares the coordinates of the retrieved item of interest with the current location coordinates. If the item of interest's coordinates falls outside the user's proximate-zone 318 then the processing unit 230 will display a straight line heading representation on the display along with an approximate distance between the current location and the item of interest. An equivalent audio description similar to one below is also provided.
“In front approximately fifty feet”
“To your right approximately forty five feet”

This will be repeated at set interviews until the item of interest is within the user's proximate-zone 318. The direction and distance are determined using simple geometry on the coordinates of the item of interest and the user's current location. Once the user has maneuvered such that the item of interest falls within the proximate-zone 318 the description of the item of interest will be display. An equivalent audio description is transmitted to the audio driver 226 and then to the line-out socket 116. Prior to transmission, the feed thru controller 224 disconnects the line-in signal thus muting the line-in source. When within the proximate zone 318 direction determinations are derived from the direction sensing receiver 218. This alleviates direction calculation problems in situation where the resolution of the location sensing receiver 214 is less than the proximate-zone 318 radius. Once the description is completed, the processing unit 230 searches the tour database to determine if the tour is complete, i.e. if all item of interest for the tour has been traversed. If not completed then the data for the next item of interest is retrieved by the processing unit and the above program flow is repeated. If the tour is completed then program flow is ended and the user is prompted to select a new tour.

Conclusion, Ramifications and Scope of Invention.

Thus, the reader will see that the guided tour system of the invention provides a portable yet economical system for providing guided tours. Furthermore, the apparatus has the additional advantages in that
it can calculate the direction and distance from the user to the next item of interest;
it can provide both textual and or audio description of the item of interest;

and
it can access a plurality of tour data from the memory array.

While my above description contains much specificity, these should not be construed as limitations on the scope of the invention, but rather as an exemplification of one preferred embodiment thereof. Many other variations are possible.

Accordingly, the scope of the invention should be determined not by the embodiment illustrated, but by the appended claims and their legal equivalent.

1. A guided tour system comprising:
a location sensing receiver for receiving location information and determining a current location thereof;
a direction sensing receiver for receiving direction information and determining a current direction thereof;
a user selectable database containing a plurality of tours each tour containing a plurality of items of interest;
means for selecting a particular tour and a current item of interest;
means for determining a distance and direction from the current location to the current item of interest;
means for determining whether the current item of interest is within a proximate-zone of the current location;
a display device for providing visual indication of the direction and distance from the current location to the current item of interest and for providing visual indication of a description of the current item of interest;
means for determining a next item of interest and making it the current item of interest.

2. The guided tour system as defined in claim 1 wherein said display device consist of a LCD display.

3. A method of providing guide information for a tour, said method comprising the steps of;
receiving location information with a GPS receiver and determining a current location thereof;
receiving direction information with a magnetic field receiver and determining a current direction thereof;
storing a database containing a plurality of tours with associated plurality of items of interest;
selecting one tour from the database and a current item of interest;
determining a distance and direction from the current location to the current item of interest;
determining whether the current item of interest is within a proximate-zone of the current location;
determining a next item of interest and making it the current item of interest;
displaying the distance and direction from the current location to the current item of interest.
